(19) United States
(12) Patent Application Publication
(10) Pub. No.: US 2021/0354855 A1
(43) Pub. Date: Nov. 18, 2021

(54) METHOD FOR FLIGHT DATA RECORDING OF UNMANNED AERIAL VEHICLE USING BLOCKCHAIN TECHNOLOGY AND APPARATUS FOR THE SAME

(71) Applicant: ELECTRONICS AND TELECOMMUNICATIONS RESEARCH INSTITUTE, Daejeon (KR)

(72) Inventors: Kyeong-Ho KIM, Daejeon (KR); Deokjin KIM, Daejeon (KR); Sangwook LEE, Daejeon (KR)

(21) Appl. No.: 16/902,329

(22) Filed: Jun. 16, 2020

(30) Foreign Application Priority Data
May 15, 2020 (KR) 10-2020-0058122

(51) Int. Cl. B64F 5/60; G07C 3/04; H04L 9/32; G07C 5/08; G01S 19/01

(52) U.S. Cl. CPC B64F 5/60; G07C 3/04; G01S 19/01; G07C 5/0816; H04L 9/3247

(57) ABSTRACT

Disclosed herein is a method for recording flight data of an unmanned aerial vehicle (UAV) using blockchain technology. The method includes collecting sensor data from a sensor installed in the UAV, collecting location information of the UAV from a GPS installed therein, estimating the flight status of the UAV based on a control signal, the sensor data, and the location information, detecting an abnormal condition by comparing the flight status with the flight plan of the UAV, generating signature information corresponding to surroundings at a corresponding time based on peripheral signals collected from a receiver installed in the UAV, generating a transmission data block capable of being registered in a blockchain based on the flight status, the abnormal condition, and the signature information, transmitting the transmission data block to a flight data registration apparatus, and registering the transmission data block, received by the flight data registration apparatus, in the blockchain.

### CROSS REFERENCE TO RELATED APPLICATION

This application claims the benefit of Korean Patent Application No. 10-2020-0058122, filed May 15, 2020, which is hereby incorporated by reference in its entirety into this application.

### BACKGROUND OF THE INVENTION

### 1. Technical Field

The present invention relates to a method for recording flight data of an unmanned aerial vehicle and an apparatus for the same.

### 2. Description of the Related Art

A low altitude unmanned aerial vehicle (drone) is operated under the control of a ground control station or under a predefined flight program without the boarding of pilot. The unmanned aerial vehicles were originally developed for military uses. However, with the development of quadcopters and the like, the level of difficulty of operation and the prices thereof are lowered, so the public use of unmanned aerial vehicles for leisure has increased. Also, unmanned aerial vehicles having various functions have been recently developed and are operated for public purposes or the business of corporations (e.g., delivery, pest control, prevention of epidemics, and the like).

The increasing use of unmanned aerial vehicles increases the risk of occurrence of accidents. An accident involving an unmanned aerial vehicle may occur due to a collision with another device or a crash into terrain or an obstacle, but the wind direction, the wind speed, and the like may also affect the incidence of accidents. Further, threats such as invasion of privacy, entry into restricted airspace, collisions with aircraft and the like are present.

Generally, in order to investigate aircraft accidents, affairs related thereto, and the like, flight-data-recording devices, such as black boxes and the like, are used in the aviation field. However, many unmanned aerial vehicles have no flight-data-recording device installed therein due to the high price thereof. As a result, when an accident involving an unmanned aerial vehicle occurs or when an illegal act is committed using an unmanned aerial vehicle, it is difficult to track down the user of the unmanned aerial vehicle or to identify the cause of the accident due to the absence of such recording devices.

Also, even in the case where such a recording device is installed in an unmanned aerial vehicle, when an incident occurs, it is almost impossible to use current technology, which merely records simple flight data and information about the owner of the unmanned aerial vehicle, to identify whether responsibility for an accident lies with the manufacturer or the user of the unmanned aerial vehicle, and particularly to identify whether an incident was intentional or due to a fault. That is, an incident involving an unmanned aerial vehicle may be caused by a deliberate action or negligence. If the cause is a deliberate action, it is necessary to prove intentionality, which may be difficult. In the case of negligence, the cause of the accident may be a user's mistake during the operation, the fault of the unmanned aerial vehicle itself, or the like, but the current recording technology is not sufficient to indicate whether the cause is a user's mistake during the operation or a fault of the unmanned aerial vehicle.

Accordingly, there is increasing need for an apparatus for recording flight data of an unmanned aerial vehicle in order to correctly identify the cause of an accident and the entity that is responsible for the accident.

### DOCUMENTS OF RELATED ART

(Patent Document 1) Korean Patent No. 10-1466953, published on Nov. 24, 2014.

### SUMMARY OF THE INVENTION

An object of the present invention is to provide a method for recording flight data and an apparatus for the same through which, when an incident involving an low altitude unmanned aerial vehicle occurs, the cause thereof can be correctly identified.

Another object of the present invention is to generate flight data using a separate device independent of an unmanned aerial vehicle, thereby providing technology to generate mutually trusted flight data.

A further object of the present invention is to provide an apparatus and method for recording reliable flight data, which satisfies the prevention of manipulation of flight data and the prevention of user flight denial by using signature and blockchain technology.

A method for recording flight data of an unmanned aerial vehicle using blockchain technology according to an embodiment includes collecting sensor data from a sensor installed in the unmanned aerial vehicle; collecting location information of the unmanned aerial vehicle from a GPS installed in the unmanned aerial vehicle; estimating a flight status of the unmanned aerial vehicle based on a control signal, the sensor data, and the position information; detecting an abnormal condition by comparing the flight status with a flight plan of the unmanned aerial vehicle; generating signature information corresponding to a surrounding environment at a corresponding time based on a peripheral signal collected from a receiver installed in the unmanned aerial vehicle; generating a transmission data block capable of being registered in a blockchain based on the flight status, the abnormal condition, and the signature information; transmitting the transmission data block to a flight data registration apparatus; and registering the transmission data block received by the flight data registration apparatus in the blockchain.

Here, the collecting the location information may include estimating position information from the sensor data; and collecting the location information based on GPS data received from the GPS and the position information.

Here, the estimating the flight status may include collecting the control signal from the receiver; receiving the control signal, the position information, and the location information; and estimating the flight status based on the control signal, the position information, and the location information.

Here, the generating the transmission data block may include generating transmission data based on the flight status, the abnormal condition, and the signature information; signing the transmission data using a signature method; and converting the signed transmission data into the transmission data block capable of being registered in the blockchain.

Here, the estimating the position information may be configured to estimate a pitch, a roll, a yaw and a heading of the unmanned aerial vehicle from the sensor data of the unmanned aerial vehicle.

Here, the peripheral signal may be a radio broadcast signal or a signal for generating signature information, being transmitted by a receiving station.

Here, the registering the transmission data block may include receiving the transmission data block; and registering, by a blockchain node, the transmission data block in the blockchain.

Here, the receiving the transmission data block may include verifying integrity of the received transmission data block; and transmitting a request for registration in the blockchain to the blockchain node when the integrity is verified.

Here, the registering, by the blockchain node, the transmission data block may include receiving the request for registration of the block in the blockchain; determining whether to register the block using a blockchain consensus algorithm; removing the block when the registration is denied; and registering the block in the blockchain when the registration is approved.

Here, the method may further include broadcasting a signal for generating signature information.

An apparatus for generating flight data of an unmanned aerial vehicle using blockchain technology according to an embodiment may include a processor for collecting sensor data from a sensor installed in the unmanned aerial vehicle, collecting location information of the unmanned aerial vehicle from a GPS installed in the unmanned aerial vehicle, estimating a flight status of the unmanned aerial vehicle based on a control signal, the sensor data, and the location information, detecting an abnormal condition by comparing the flight status with a flight plan of the unmanned aerial vehicle, generating signature information corresponding to a surrounding environment at a corresponding time based on a peripheral signal collected from a receiver installed in the unmanned aerial vehicle, generating a transmission data block capable of being registered in a blockchain based on the flight status, the abnormal condition, and the signature information, and transmitting the transmission data block to a flight data registration apparatus; and memory for storing the transmission data block.

Here, the processor may estimate position information from the sensor data, and may collect the location information based on GPS data received from the GPS and the position information.

Here, the processor may collect the control signal from the receiver, receive the control signal, the position information, and the location information, and estimate the flight status based on the control signal, the position information, and the location information.

Here, the processor may generate transmission data based on the flight status, the abnormal condition, and the signature information, sign the transmission data using a signature method, and convert the signed transmission data into the transmission data block capable of being registered in the blockchain.

Here, the processor may estimate a pitch, a roll, a yaw and a heading of the unmanned aerial vehicle from the sensor data of the unmanned aerial vehicle.

Here, the peripheral signal may include a radio broadcast signal or a signal for generating signature information, being transmitted by a receiving station.

An apparatus for registering flight data of an unmanned aerial vehicle using blockchain technology according to an embodiment may include a processor for receiving a transmission data block transmitted from a flight data generation apparatus and registering the received transmission data block in a blockchain; and memory for storing the transmission data block.

Here, the processor may verify integrity of the received transmission data block, and may transmit a request for registration in the blockchain to a blockchain node when the integrity is verified.

Here, the blockchain node may receive the request for registration of the block in the blockchain, may determine whether to register the block using a blockchain consensus algorithm, may remove the block when the registration is denied, and may register the block in the blockchain when the registration is approved.

Here, the processor may broadcast a signal for generating signature information.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a view illustrating an environment in which a system for recording flight data of an unmanned aerial vehicle using blockchain technology according to an embodiment is used;

FIG. 2 is a block diagram illustrating an example of a system for recording flight data of an unmanned aerial vehicle using blockchain technology;

FIG. 3 is a view illustrating an example of the apparatus for generating flight data illustrated in FIG. 2;

FIG. 4 is a view illustrating an example of the apparatus for registering flight data illustrated in FIG. 2;

FIG. 5 is a view illustrating a flowchart for the apparatus for generating flight data illustrated in FIG. 2;

FIG. 6 is a view illustrating a flowchart for the receiving station illustrated in FIG. 4;

FIG. 7 is a view illustrating a flowchart for the blockchain node illustrated in FIG. 4; and

FIG. 8 is a view illustrating the configuration of a computer system according to an embodiment.

### DESCRIPTION OF THE PREFERRED EMBODIMENTS

The advantages and features of the present invention and methods of achieving them will be apparent from the following exemplary embodiments to be described in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the teachings of the present invention.

The terms used herein are for the purpose of describing particular embodiments only and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

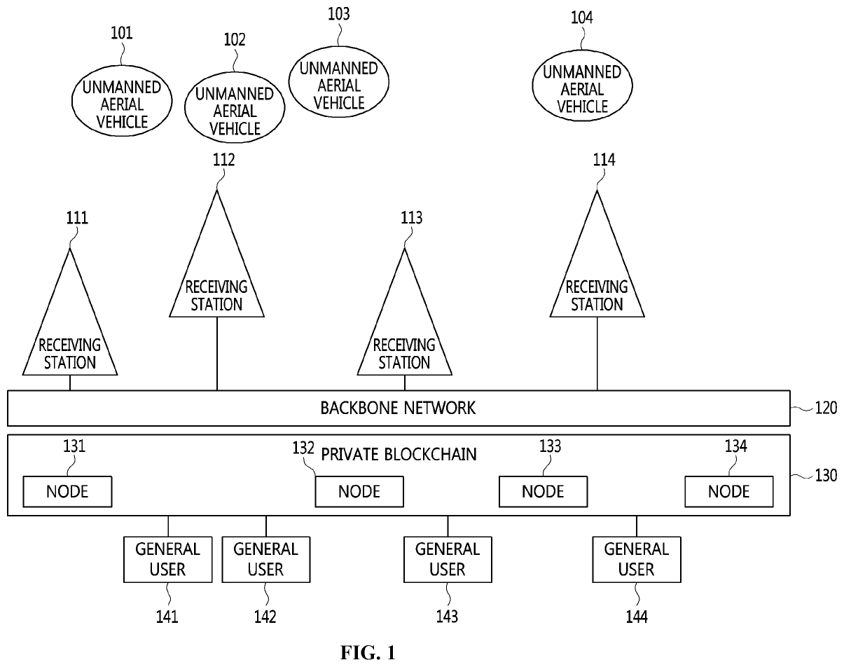

Hereinafter, a method for recording flight data of an unmanned aerial vehicle using blockchain technology and an apparatus for the same according to an embodiment will be described in detail with reference to FIGS. 1 to 8.

FIG. 1 is a view illustrating an environment in which a system for recording flight data of an unmanned aerial vehicle using blockchain technology according to an embodiment is used.

Referring to FIG. 1, the environment in which the system for recording flight data is used includes multiple unmanned aerial vehicles 101, 102, 103 and 104, a backbone network 120 to which multiple receiving stations 111, 112, 113 and 114 are connected, and multiple blockchain nodes 131, 132, 133 and 134 that form a private blockchain 130. The blockchain 130 may be read by general users 141, 142 143 and 144. FIG. 1 illustrates the four unmanned aerial vehicles, the four receiving stations, the four blockchain nodes, and the four users, but the number thereof may be changed depending on the use environment.

When the unmanned aerial vehicle is operated, the system for recording flight data of the unmanned aerial vehicle using blockchain technology according to an embodiment generates flight data, transmits the same to a remote site, and uploads the same in real time. That is, the flight data generation apparatus of the system, which is installed in the unmanned aerial vehicle, generates flight data and transmits the same. Then, the flight data registration apparatus of the system receives the flight data and registers the same. Here, the receiving station receives the flight data and registers the same in a blockchain node.

More specifically, the multiple receiving stations may be installed in the field based on the radius of signal coverage, the degree of congestion, and the like. The receiving station functions to receive a signal transmitted from the flight data generation apparatus and to upload the same to the blockchain. Depending on the circumstances, the receiving station may broadcast a signal that is required in order for the flight data generation apparatus to generate signature information.

The blockchain node verifies the block transmitted by the receiving station and stores and registers the same in the blockchain. The block may be verified through a predefined consensus algorithm.

The flight data registered in the blockchain may be used as evidence for determining the cause of an incident. Also, a signature method using specific information about the unmanned aerial vehicle or the user thereof is applied to the flight data, whereby the user is prevented from denying having flown the unmanned aerial vehicle. Also, the signed data is stored in the blockchain placed in a remote site, whereby the data becomes tamperproof and reliable. Therefore, there is an advantage in that the flight data is admissible as evidence when an incident is investigated.

In the system, only limited participants are allowed to generate data and register data in the blockchain, and the participants are able to generate and register only their own flight data. General users may read the flight data registered in the blockchain anytime. Therefore, general users may retrieve and read their own data or flight data of other unmanned aerial vehicles when necessary.

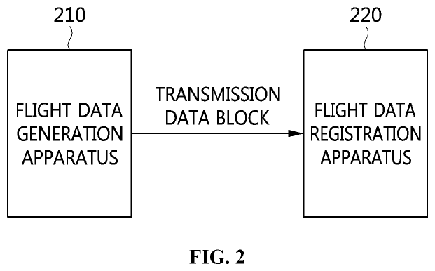

FIG. 2 is a block diagram illustrating an example of a system for recording flight data of an unmanned aerial vehicle using blockchain technology according to an embodiment.

Referring to FIG. 2, the system for recording flight data of an unmanned aerial vehicle using blockchain technology may include a flight data generation apparatus 210 and a flight data registration apparatus 220. Also, the system transmits a transmission data block, generated by the flight data generation apparatus 210, to the flight data registration apparatus 220, thereby recording the flight data of the unmanned aerial vehicle in the blockchain.

The flight data generation apparatus 210 may collect sensor data through a sensor installed in the unmanned aerial vehicle.

That is, data measured by various sensors, such as a gyro sensor, a geomagnetic sensor, a barometric pressure sensor, an ultrasonic sensor, an optical sensor, and the like, installed in the unmanned aerial vehicle, is collected. Here, the sensors that are used may be dependent on the configuration of the unmanned aerial vehicle, and the sensors are not limited.

The flight data generation apparatus 210 may collect information about the location of the unmanned aerial vehicle using the GPS installed in the unmanned aerial vehicle. Here, position (orientation) information is estimated using the sensor data in order to collect the location information, and the location information may be collected based on the position information and GPS data received from the GPS.

The flight data generation apparatus 210 uses not only the GPS data but also the position information estimated based on the sensor data in order to detect the current location of the unmanned aerial vehicle. Generally, airplanes measure the positions and altitudes thereof using GPS data. However, due to limitations in detecting a location using a GPS, a location error may occur, and it may be impossible to detect location information due to the loss of a GPS signal. In order to solve these problems, the flight data generation apparatus not only collects location information using the GPS but also estimates the position (posture) and the travel route of the unmanned aerial vehicle using the data acquired from a sensor data collection module, thereby calibrating the location information of the unmanned aerial vehicle using all of the information.

The position information may include the pitch, roll, and yaw of the unmanned aerial vehicle and the heading thereof. Based on the sensor data collected by the flight data generation apparatus 210, the pitch, roll, yaw, and the heading of the unmanned aerial vehicle may be identified. Generally, the motion of an airplane is classified into a longitudinal motion (motion in a vertical direction) and a lateral motion (motion in a horizontal direction). Here, the longitudinal motion corresponds to the pitch of the airplane, and the lateral motion corresponds to the yaw and roll of the airplane. That is, the pitch indicates a motion in which the nose of the airplane moves up and down, the yaw indicates a motion in which the nose of the airplane moves left and right, and the roll indicates a motion in which the nose of the airplane rotates clockwise and counterclockwise. Accordingly, when the heading of the unmanned aerial vehicle is known and when the pitch, roll, and yaw thereof are detected, the position information of the unmanned aerial vehicle may be estimated.

Also, the flight data generation apparatus 210 may estimate the flight status of the unmanned aerial vehicle based on a control signal, the sensor data, and the location information. Here, in order to estimate the flight status, the control signal may be collected from a receiver, and the control signal, the position information, and the location information may be received. Then, the flight status may be estimated based on the control signal, the position information, and the location information. That is, the flight data generation apparatus 210 may calculate the currently estimated flight status using the location information, the position information, and the received control signal, and may calculate the actual navigation information (flight status) of the unmanned aerial vehicle therefrom. Here, the control signal is a control signal from a user or a ground control station, which is necessary for remotely controlling the unmanned aerial vehicle.

Also, the flight data generation apparatus 210 may detect an abnormal condition by comparing the flight status with the flight plan of the unmanned aerial vehicle. That is, the previously stored flight plan is compared with the estimated flight status, whereby whether an abnormal condition occurs is checked. When it is determined based on the result of checking that an abnormal condition occurs, an alarm is recorded inside, and the alarm may be transmitted to the outside through a transmission module depending on the circumstances.

Also, based on peripheral signals collected from the receiver installed in the unmanned aerial vehicle, the flight data generation apparatus 210 may generate signature information corresponding to the surrounding environment at the corresponding time. Here, the peripheral signal may be a radio broadcast signal or a signal for generating signature information, which is transmitted by the receiving station.

That is, the flight data generation apparatus 210 may collect the peripheral signals through the receiver, and may generate signature information using the collected peripheral signals. Here, the generated signature information is information about the surrounding environment at the corresponding time. Because the fact that the unmanned aerial vehicle was flying at the corresponding location at the corresponding time can be confirmed through the signature information, the signature information may be used as data for proving the veracity of the flight data record. Here, the peripheral signal may be any of various types of signals, such as a specific signal transmitted by the receiving station so as to be used for generating signature information, AM/FM radio frequencies, and the like.

Also, the flight data generation apparatus 210 may generate a transmission data block that can be registered in the blockchain based on the flight status, information about the abnormal condition, and the signature information. Here, in order to generate the transmission data block, transmission data may be generated based on the flight status, the information about the abnormal condition, and the signature information, the transmission data may be signed using a signature method, and the signed data may be converted into the transmission data block, which can be registered in the blockchain.

That is, the flight data generation apparatus 210 generates data for transmitting the collected and generated flight data to the outside. Here, the data is signed for nonrepudiation of the data and prevention of data manipulation. The method for signing the data is a general encryption method based on a specific value capable of authenticating a user or a device, a signature method, or the like, and any of various methods may be applied depending on the circumstances without limiting the category thereof. Here, unique information acquired through a separate preflight approval or registration process may be used as the specific value for signing the data. Then, the signed data may be converted into a block form that can be registered in the blockchain.

Also, the flight data generation apparatus 210 may store data that needs to be recorded, among data generated in the process of collecting and generating the flight data, in the apparatus. The location at which such data is stored may be, for example, internal memory, USB memory, or the like. Also, the flight data generation apparatus 210 may transmit the generated transmission data block to the flight data registration apparatus 220. Depending on the circumstances, the alarm information generated in the flight-plan-checking step may be transmitted to the flight data registration apparatus 220.

The flight data registration apparatus 220 may register the received transmission data block in the blockchain. Here, in order to register the transmission data block in the blockchain, the flight data registration apparatus 220 may receive the transmission data block, and a blockchain node may register the transmission data block in the blockchain. Here, in order to register the transmission data block, the integrity of the received transmission data block is checked. Then, when the integrity is verified, a request for registration in the blockchain may be transmitted to the blockchain node. Here, in order for the blockchain node to register the transmission data block in the blockchain, the blockchain node receives the request for registration in the blockchain and determines whether to register the block using a blockchain consensus algorithm. Here, when registration is denied, the block is removed, whereas when registration is approved, the block may be registered in the blockchain.

The present invention applies blockchain technology for nonrepudiation of flight data and prevention of falsification (manipulation) of flight data. The blockchain of the flight data registration apparatus 220 may be configured as a private blockchain. That is, limited participants may be allowed to make determinations on the management of the nodes and blocks of the blockchain. General users may read the blocks anytime with user permissions in order to identify the cause of an incident or accident, and may search their own data or other navigation data.

In order to enable the flight data registration apparatus 220 to receive the transmission data block, multiple receiving stations having reception functions may be installed in the field based on the radius of signal coverage, the degree of congestion, and the like. The receiving stations function to receive the signal transmitted from the flight data generation apparatus 210 and to send registration requests to the blockchain node. Depending on the circumstances, each receiving station may broadcast a signal that is required in order for the flight data generation apparatus 210 to generate signature information.

The blockchain node of the flight data registration apparatus 220 may verify the transmission data block received by the receiving station, and may append only blocks, registration of which is approved through the verification, to the blockchain and confirm the same. The block may be verified through a predefined consensus algorithm.

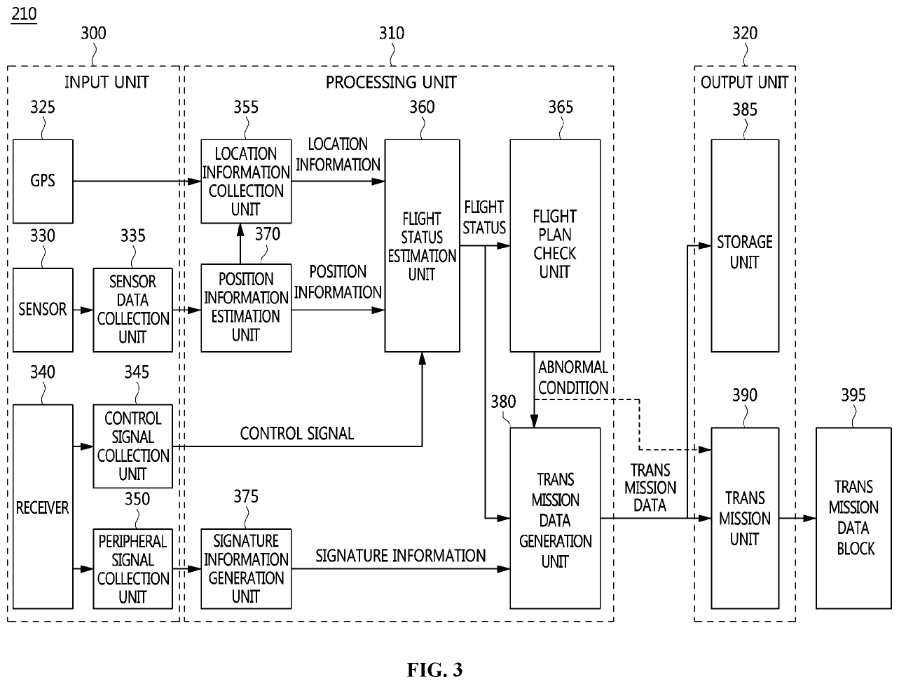

FIG. 3 is a view illustrating an example of the flight data generation apparatus 210 illustrated in FIG. 2.

Referring to FIG. 3, the flight data generation apparatus 210 may include an input unit 300, a processing unit 310, and an output unit 320. The input unit 300 collects information about the status of an unmanned aerial vehicle and the surrounding environment through a GPS 325, a sensor 330, and a receiver 340. The processing unit 310 identifies a position based on the data collected by the input unit 300 and estimates a flight status and the like. The output unit 320 stores the data processed by the processing unit 310 in the internal storage and transmits the same to the outside. That is, the flight data generation apparatus 210 is configured such that the processing unit 310 extracts meaningful information from the data collected by the input unit 300 and the output unit 320 outputs the meaningful information as reliable information using a signature and blockchain technology.

The input unit 300 includes the GPS 325, the sensor 330, and the receiver 340, and may further include a sensor data collection unit 335, a control signal collection unit 345, and a peripheral signal collection unit 350.

The most important consideration in the flight of an unmanned aerial vehicle is to maintain the state of the body thereof and to fly along a desired route. To this end, a sensor for identifying the state of the body of the unmanned aerial vehicle and the surrounding environment is installed.

The sensor data collection unit 335 may collect sensor data through the sensor installed in the unmanned aerial vehicle. That is, data measured by various sensors, such as a gyro sensor, a geomagnetic sensor, a barometric pressure sensor, an ultrasonic sensor, an optical sensor, and the like, installed in the body of the unmanned aerial vehicle, may be collected.

The control signal collection unit 345 may collect a control signal from a user or a ground control station, which is necessary for remotely controlling the unmanned aerial vehicle.

The peripheral signal collection unit 350 may collect a peripheral signal through the receiver. The collected peripheral signal may be used later when a signature information generation unit 375 generates signature information. The generated signature information may be used as data for proving the veracity of the flight data of the unmanned aerial vehicle. The peripheral signal may be any of various types of signals, such as a specific signal transmitted by a receiving station so as to be used for generating signature information, AM/FM radio frequencies, and the like.

The processing unit 310 may include a location information collection unit 355, a flight status estimation unit 360, a flight plan check unit 365, a position information estimation unit 370, the signature information generation unit 375, and a transmission data generation unit 380.

The location information collection unit 355 may collect information about the position of the unmanned aerial vehicle from the GPS installed in the unmanned aerial vehicle. Here, the location information collection unit 355 may collect the location information based on the position information generated by the position information estimation unit 370 and the GPS data received from the GPS.

First, the position information estimation unit 370 may estimate the pitch, the roll, the yaw, and the heading of the unmanned aerial vehicle based on the sensor data generated by the sensor data collection unit 335. The pitch indicates a motion in which a nose moves up and down, the yaw indicates a motion in which the nose moves left and right, and the roll indicates a motion in which the nose rotates clockwise and counterclockwise. Accordingly, when the heading of the unmanned aerial vehicle is known and when the pitch, roll, and yaw thereof are detected, the position information thereof may be estimated.

The location information collection unit 355 is a block for detecting the current location of the unmanned aerial vehicle. Generally, airplanes measure the positions and altitudes thereof using GPS data. However, due to limitations in detecting a location using a GPS, a location error may occur, and it may be impossible to detect location information due to the loss of a GPS signal. In order to solve these problems, the present invention not only collects location information using the GPS but also estimates the position (posture) and the travel route using the data acquired from the sensor data collection unit 335, thereby calibrating the location information of the unmanned aerial vehicle using the information about the position and the travel route.

The flight status estimation unit 360 may estimate the flight status of the unmanned aerial vehicle based on a control signal, the sensor data, and the location information. Here, the flight status estimation unit 360 receives the control signal collected by the control signal collection unit 345, the location information generated by the location information collection unit 355, and the position information generated by the position information estimation unit 370. Then, the currently estimated flight status is calculated using the control signal, the location information, and the position information. As the result, the actual navigation information of the unmanned aerial vehicle may be calculated. The control signal is a control signal from a user or a ground control station, which is for remotely controlling the unmanned aerial vehicle.

The flight plan check unit 365 compares the flight status calculated by the flight status estimation unit 360 with the flight plan of the unmanned aerial vehicle, thereby checking whether an abnormal condition occurs. The abnormal condition may be detected through the checking, and an alarm related to the abnormal condition may be recorded in a storage unit 385, or may be transmitted to the outside through a transmission unit 390 depending on the circumstances.

The signature information generation unit 375 may generate signature information corresponding to the surrounding environment at the corresponding time based on the peripheral signals collected from the receiver installed in the unmanned aerial vehicle. That is, signature information may be generated based on the peripheral signals collected by the peripheral signal collection unit 350. The signature information may be used as information for proving the fact that the unmanned aerial vehicle was flying at the corresponding location at the corresponding time through the information about the surrounding environment at the corresponding time. Here, the peripheral signal may be any of various types of signals, such as a signal transmitted by the receiving station so as to be used for generating the signature information, radio frequencies, and the like.

The transmission data generation unit 380 generates data for transmitting the flight data, which is collected by the input unit 300 and generated by the blocks of the processing unit 310, to the outside. Here, the data is signed in order to prevent falsification or repudiation thereof. The method for signing the data may apply any of various methods, such as a general cryptography method based on a specific value capable of authenticating a user or a device, a signature method, and the like, depending on the circumstances, and the method is not limited in the present invention. Then, the signed data is converted into a block form that can be registered in the blockchain. Here, unique information that is acquired through an approval or registration process before a flight may be used as the specific value for signing the data.

The output unit 320 may include the storage unit 385 and the transmission unit 390. The output unit 320 generates a transmission data block 395 by receiving the transmission data from the transmission data generation unit 380 and transmits the transmission data block.

The storage unit 385 may perform the operation of storing data that needs to be recorded, among the flight data generated in the input unit 300 and the processing unit 310. The storage unit 385 may be implemented as internal memory, USB memory, or the like depending on the application.

The transmission unit 390 may transmit the transmission data block 395 generated by the transmission data generation unit 380 to the receiving station of the flight data registration apparatus. Depending on the circumstances, the transmission unit 390 may transmit the alarm information generated by the flight plan check unit 365 to the receiving station.

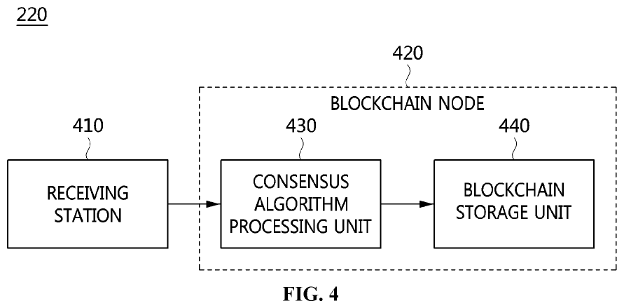

FIG. 4 is a view illustrating an example of the flight data registration apparatus 220 of FIG. 2.

Referring to FIG. 4, the flight data registration apparatus 220 may include a receiving station 410 and a blockchain node 420. The blockchain node 420 may include a consensus algorithm processing unit 430 and a blockchain storage unit 440.

The present invention applies blockchain technology for nonrepudiation of flight data and prevention of falsification of the flight data. The blockchain of the flight data registration apparatus 220 is configured as a private blockchain. The management of the nodes of the blockchain and matters related to blocks are determined by limited participants, such as relevant organizations and the like. General users may read the blocks with user permission, and may search their data or other navigation data.

The receiving station 410 may comprise multiple receiving stations installed in the field based on the radius of signal coverage, the degree of congestion, and the like. The receiving stations function to receive the signal transmitted from the flight data generation apparatus and to transmit a registration request to the blockchain node. Depending on the circumstances, the receiving station may broadcast a signal that is required in order for the flight data generation apparatus to generate a signature.

The blockchain node 420 verifies the transmission data block, which is received by the receiving station, appends only the block, registration of which is approved through the verification, to the blockchain, and confirms the same. The block may be verified through a predefined consensus algorithm.

In response to reception of the transmission data block by the receiving station 410, the consensus algorithm processing unit 430 of the blockchain node 420 may determine whether to register the block using the consensus algorithm agreed upon between blockchain nodes. That is, whether the block is approved by the consensus algorithm is determined. If the block is determined to be approved by the consensus algorithm, it is determined that registration of the block is approved, but if not, it is determined that registration of the block is denied.

The blockchain storage unit 440 of the blockchain node 420 may store only blocks, registration of which is determined to be approved by the consensus algorithm processing unit 430, in the blockchain. That is, blocks, registration of which is denied by the consensus algorithm processing unit 430, are removed, and blocks, registration of which is approved, are appended to the blockchain and confirmed.

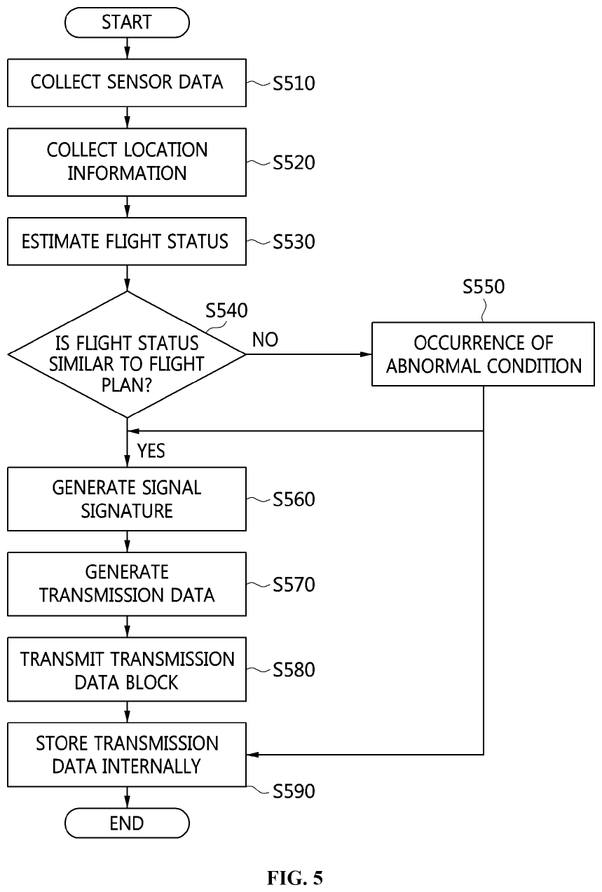

FIG. 5 is a view illustrating a flowchart for the flight data generation apparatus 210 illustrated in FIG. 2.

Referring to FIG. 5, the flight data generation apparatus 210 starts operation at the time of commencement of driving of the apparatus or flight.

The flight data generation apparatus 210 collects sensor data from a sensor installed in an unmanned aerial vehicle at step S510 after the start of the operation.

Then, the flight data generation apparatus 210 collects location information of the unmanned aerial vehicle from a GPS installed in the unmanned aerial vehicle at step S520. Here, position information is estimated from the sensor data in order to collect the location information, and the location information may be collected based on the position information and GPS data received from the GPS. When the location information is collected using only the GPS data, a location error may occur due to limitations in detection of a location using the GPS, or it may be impossible to detect the location information due to the loss of a GPS signal. Therefore, in order to solve these problems, the location information collected from the GPS may be calibrated using the position information estimated from the sensor data. The position information may include pitch, indicating the longitudinal motion of the unmanned aerial vehicle, yaw and roll, indicating the lateral motion of the unmanned aerial vehicle, and the heading of the body of the unmanned aerial vehicle.

Then, the flight data generation apparatus 210 estimates the current flight route and position of the unmanned aerial vehicle by estimating the flight status thereof at step S530. That is, the flight status of the unmanned aerial vehicle may be estimated based on a control signal, the sensor data, and the location information. Here, in order to estimate the flight status, the flight data generation apparatus 210 may collect the control signal from the receiver, receive the control signal, the position information, and the location information, calculate the currently estimated flight status based on the signals and information, and calculate the actual navigation information.

Then, the flight data generation apparatus 210 compares the flight status with the flight plan of the unmanned aerial vehicle at step S540. When the flight status is similar to the flight plan, the state is determined to be a normal condition, and generating a signal signature may be performed at step S560 as the next step. However, when the flight status is not similar to the flight plan, the state is determined to be an abnormal condition, information thereabout is generated at step S550, and the information thereabout may be immediately stored in the apparatus at step S590. Depending on the circumstances, an alarm for announcing the abnormal condition may be transmitted to the outside through a transmission unit.

Then, the flight data generation apparatus 210 generates signal signature information based on a peripheral signal at step S560. The generated signature information is information about the surrounding environment at the corresponding time, and indicates that the unmanned aerial vehicle was flying at the corresponding location at the corresponding time. Therefore, the signature information may be used later as data for proving the veracity of the flight data record. Here, the peripheral signal may be a specific signal that is transmitted by a receiving station so as to be used for generating signature information, a radio broadcast signal, or the like.

Then, the flight data generation apparatus 210 generates transmission data at step S570 based on the results acquired and calculated up to the present time. That is, transmission data is generated based on the flight status, information about the abnormal condition, and the signature information, the transmission data is signed using a signature method, and the signed data may be converted into a transmission data block that can be registered in the blockchain.

Then, the flight data generation apparatus 210 transmits the transmission data block at step S580. Also, the transmission data or the transmission data block is also stored in the unmanned aerial vehicle at step S590.

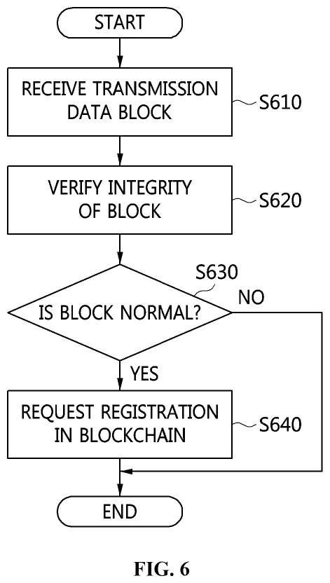

FIG. 6 is a view illustrating a flowchart for the receiving station 410 illustrated in FIG. 4.

Referring to FIG. 6, the receiving station 410 receives the transmission data block that is generated by the flight data generation apparatus and transmitted therefrom at step S610. Then, the receiving station 410 verifies the integrity of the block at step S620. When the block is determined to be a normal block because the integrity thereof is verified, a request for registration in a blockchain is transmitted to a blockchain node at step S640. When the block is determined to be abnormal because the integrity thereof is not verified, the process goes to a termination step.

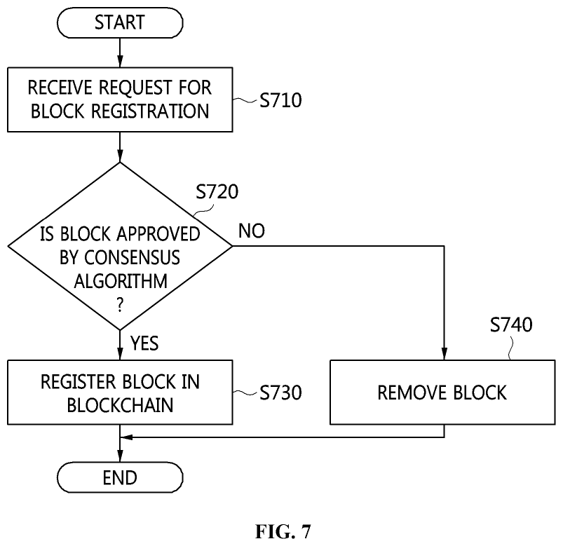

FIG. 7 is a view illustrating a flowchart for the blockchain node 420 illustrated in FIG. 4.

Referring to FIG. 7, the blockchain node 420 receives a request to register a block in the blockchain from the receiving station at step S710. Then, whether the block is approved by a consensus algorithm is determined at step S720. When the block is approved by a consensus algorithm, the block is registered in the blockchain at step S730. When the block is not approved by a consensus algorithm, the block is removed at step S740.

That is, the blockchain node 420 verifies the transmission data block received by the receiving station, in which case the consensus algorithm is used therefor. The consensus algorithm is a blockchain algorithm previously determined by participants that manage the private blockchain in which the blockchain node is included. Therefore, only blocks, registration of which is approved through the verification using the consensus algorithm, may be appended to the blockchain and confirmed.

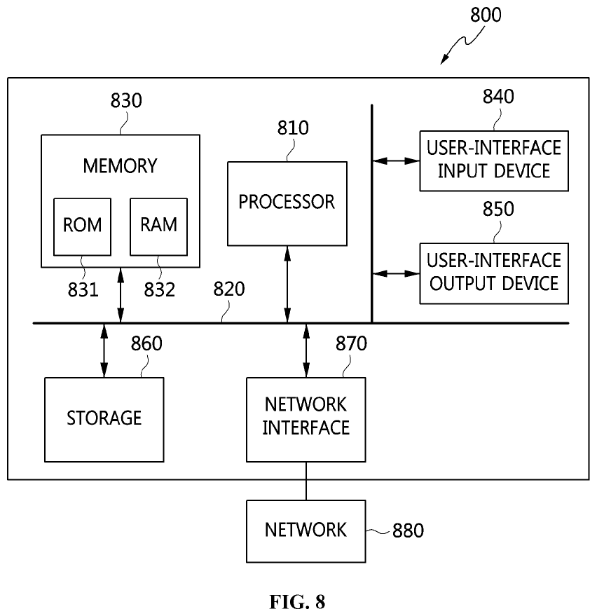

FIG. 8 is a view illustrating the configuration of a computer system according to an embodiment.

An apparatus for generating flight data of an unmanned aerial vehicle using blockchain technology or an apparatus for recording flight data of an unmanned aerial vehicle using blockchain technology according to an embodiment may be implemented in a computer system 800 including a computer-readable recording medium.

The computer system 800 may include one or more processors 810, memory 830, a user-interface input device 840, a user-interface output device 850, and storage 860, which communicate with each other via a bus 820. Also, the computer system 800 may further include a network interface 870 connected with a network 880. The processor 810 may be a central processing unit or a semiconductor device for executing a program or processing instructions stored in the memory 830 or the storage 860. The memory 830 and the storage 860 may be storage media including at least one of a volatile medium, a nonvolatile medium, a detachable medium, a non-detachable medium, a communication medium, and an information delivery medium. For example, the memory 830 may include ROM 831 or RAM 832.

According to the embodiment described above, the present invention may provide a method for recording flight data and an apparatus for the same through which, when an incident involving an low altitude unmanned aerial vehicle occurs, the cause of the incident may be correctly identified.

Also, the present invention generates flight data using a separate device independent of an unmanned aerial vehicle, thereby providing technology to generate mutually trusted flight data.

Also, the present invention provides an apparatus and method for recording reliable flight data, which satisfies the prevention of manipulation of flight data and the prevention of user flight denial (repudiation) by using signature and blockchain technology.

Although the embodiments of the present invention have been described with reference to the accompanying drawings, those skilled in the art will appreciate that the present invention may be practiced in other specific forms without changing the technical sprit or essential features of the present invention. Therefore, the embodiments described above are illustrative in all aspects and should not be understood as limiting the present invention.

What is claimed is:

1. A method for recording flight data of an unmanned aerial vehicle using blockchain technology, comprising:
collecting sensor data from a sensor installed in the unmanned aerial vehicle;
collecting location information of the unmanned aerial vehicle from a GPS installed in the unmanned aerial vehicle;
estimating a flight status of the unmanned aerial vehicle based on a control signal, the sensor data, and the location information;
detecting an abnormal condition by comparing the flight status with a flight plan of the unmanned aerial vehicle;
generating signature information corresponding to a surrounding environment at a corresponding time based on a peripheral signal collected from a receiver installed in the unmanned aerial vehicle;
generating a transmission data block capable of being registered in a blockchain based on the flight status, the abnormal condition, and the signature information;
transmitting the transmission data block to a flight data registration apparatus; and
registering the transmission data block received by the flight data registration apparatus in the blockchain.

2. The method of claim 1, wherein the collecting the location information comprises:
estimating position information from the sensor data; and
collecting the location information based on GPS data received from the GPS and the position information.

3. The method of claim 2, wherein the estimating the flight status comprises:
collecting the control signal from the receiver;
receiving the control signal, the position information, and the location information; and
estimating the flight status based on the control signal, the position information, and the location information.

4. The method of claim 3, wherein the generating the transmission data block comprises:
generating transmission data based on the flight status, the abnormal condition, and the signature information;
signing the transmission data using a signature method; and
converting the signed transmission data into the transmission data block capable of being registered in the blockchain.

5. The method of claim 2, wherein the estimating the position information is configured to estimate a pitch, a roll, a yaw and a heading of the unmanned aerial vehicle from the sensor data of the unmanned aerial vehicle.

6. The method of claim 1, wherein the peripheral signal includes a radio broadcast signal or a signal for generating signature information, being transmitted by a receiving station.

7. The method of claim 1, wherein the registering the transmission data block comprises:
receiving the transmission data block; and
registering, by a blockchain node, the transmission data block in the blockchain.

8. The method of claim 7, wherein the receiving the transmission data block comprises:
verifying integrity of the received transmission data block; and
transmitting a request for registration in the blockchain to the blockchain node when the integrity is verified.

9. The method of claim 8, wherein the registering, by the blockchain node, the transmission data block comprises:
receiving the request for registration of the block in the blockchain;
determining whether to register the block using a blockchain consensus algorithm;
removing the block when the registration is denied; and
registering the block in the blockchain when the registration is approved.

10. The method of claim 7, further comprising:
broadcasting a signal for generating signature information.

11. An apparatus for generating flight data of an unmanned aerial vehicle using blockchain technology, comprising:
a processor for collecting sensor data from a sensor installed in the unmanned aerial vehicle, collecting location information of the unmanned aerial vehicle from a GPS installed in the unmanned aerial vehicle, estimating a flight status of the unmanned aerial vehicle based on a control signal, the sensor data, and the position information, detecting an abnormal condition by comparing the flight status with a flight plan of the unmanned aerial vehicle, generating signature information corresponding to a surrounding environment at a corresponding time based on a peripheral signal collected from a receiver installed in the unmanned aerial vehicle, generating a transmission data block capable of being registered in a blockchain based on the flight status, the abnormal condition, and the signature information, and transmitting the transmission data block to a flight data registration apparatus; and
memory for storing the transmission data block.

12. The apparatus of claim 11, wherein the processor estimates position information from the sensor data and collects the location information based on GPS data received from the GPS and the position information.

13. The apparatus of claim 12, wherein the processor collects the control signal from the receiver, receives the control signal, the position information, and the location information, and estimates the flight status based on the control signal, the position information, and the location information.

14. The apparatus of claim 13, wherein the processor generates transmission data based on the flight status, the abnormal condition, and the signature information, signs the transmission data using a signature method, and converts the signed transmission data into the transmission data block capable of being registered in the blockchain.

15. The apparatus of claim 12, wherein the processor estimates a pitch, a roll, a yaw and a heading of the unmanned aerial vehicle from the sensor data of the unmanned aerial vehicle.

16. The apparatus of claim 11, wherein the peripheral signal includes a radio broadcast signal or a signal for generating signature information, being transmitted by a receiving station.

17. An apparatus for registering flight data of an unmanned aerial vehicle using blockchain technology, comprising:
a processor for receiving a transmission data block transmitted from a flight data generation apparatus and registering the received transmission data block in a blockchain; and
memory for storing the transmission data block.

18. The apparatus of claim 17, wherein the processor verifies integrity of the received transmission data block and transmits a request for registration in the blockchain to a blockchain node when the integrity is verified.

19. The apparatus of claim 18, wherein the blockchain node receives the request for registration of the block in the blockchain, determines whether to register the block using a blockchain consensus algorithm, removes the block when the registration is denied, and registers the block in the blockchain when the registration is approved.

20. The apparatus of claim 17, wherein the processor broadcasts a signal for generating signature information.
